(19) United States
(12) Patent Application Publication
(10) Pub. No.: US 2003/0099002 A1
(43) Pub. Date: May 29, 2003

(54) Scanner with a transparent module for providing scanning background

(76) Inventors: Chien-Liang Yeh, Hsinchu (TW); Chi-Jian Ren, Taipei (TW)

Correspondence Address: RABIN & BERDO, P.C., SUITE 500, 1101 14th STREET, N.W., WASHINGTON, DC, 20005, US

(21) Appl. No.: 10/288,587

(22) Filed: Nov. 6, 2002

(30) Foreign Application Priority Data
Nov. 6, 2001 (TW) 090127591

(51) Int. Cl. H04N 1/38; H04N 1/04

(52) U.S. Cl. 358/464; 358/474

(57) ABSTRACT

A scanner with a transparent module used for providing a scanning background is disclosed. An optical unit and a transparent module are respectively implemented in the base unit and the lifting cover in a synchronous moving manner. In the transparent module, a hollow rolling wheel has one transparent side plate and a number of color side plates. The light source is implemented in the hollow rolling wheel. When the user rotates the hollow rolling wheel causing the transparent plate to face the transparent window under the lifting cover, the optical unit then can scan the transparent content object using the light provided by the source. When the user rotates the hollow rolling wheel to select one of the color side plates to face the transparent window, then the optical unit scans the reflective content object using the selected color side plate as the color of the scanning background. Additionally, the color of the image background would be toward to the selected color of the color side plate.

This application incorporates by reference of Taiwan application Serial No. 090127591, filed Nov. 6, 2001.

### BACKGROUND OF THE INVENTION

1. Field of the Invention

This invention relates to a scanner, and more particularly, the invention relates to a scanner with a transparent module used for providing a scanning background.

2. Description of Related Art

As a result of the progress and development of the scientific technology, the integration and application of the multi-media have been a trend. The words “multi-media” usually refer to data content of various data types, such as text, image, and audio. In order to allow the data to be displayed by a format of the multi-media manner, a number of different types of multi-media devices, which can fetch the image data or audio data, have been developed. With respect to the image processing, the scanner is one of the image fetching tools that is used often.

Referring to FIG. 1, it is a drawing, schematically illustrating a conventional platform type scanner from the side view. As shown in FIG. 1, the scanner 100 includes a base member 102 and a lifting cover 104. The base unit 102 comprises a scanning platform 108, an optical unit 110, a holding rack 112 and a light source 114, wherein the optical unit further includes a reflection mirror 118, a transparent lens 120, and a photosensing device 122. Furthermore, the lifting cover 104 is coupled with the base unit 102 via the pivotal pin 106, so that the lifting cover 104 can be implemented on the base unit 102 by an open and close manner. Also, the scanning platform 108 is implemented on the base unit 102 and is facing a white board 107 on the inner side of the lifting cover 104. The scanning platform 108 can be disposed with a content object 116, which is to be scanned, and the scanning platform 108 usually is a transparent glass platform. In addition, the optical unit 110 is implemented inside the base unit 102 in a movable manner, so as to scan the content object 116. The holding rack 112 is implemented on the optical unit 110, and the light source 114 is implemented on the holding rack 112, so as to provide the light needed in the operation of scanning. Furthermore, the photosensing device 112 can be one of different types, such as a charge coupled device (CCD) module, a contact image sensor (CIS), and so on, and all of which can achieve the above function.

During the scanning process, first, the user closes the lifting cover 104 to the base unit 102 while the white board 107 is taken as the scanning background. Then, the light source 114 projects the light beam to the content object 116. The content object 116 reflects the light to the reflection mirror 118. Next, the reflection mirror 118 reflects again the light beam to the lens 120. After that, the lens 120 collects the light beam and focuses the image on the photosensing device 122, so that the photosensing device 122 can fetch the scanned image and read out the image. Of course, the user has to drive the optical unit 110 gradually, so that the optical unit 110 can be moved along the arrow direction 150, as shown in FIG. 1. As a result, the optical unit 110 is moved toward the region, that has not been scanned yet, by a small increment and again the image data belonging to the other portion of the content object 116 are fetched via the photosensing device 122. After repeating the foregoing procedural steps, the content object 116 can be gradually scanned in completion and then integrated into the full image.

For the foregoing scanner 100, it is specifically designed for the content object 116 operated in the reflection manner. However, when the user intends to scan a transparent content object, the user has to select another scanner for use. That currently is an upper transparency adapter (UTA) scanner, in which the TUA scanner has a structure about similar to the scanner but the difference is that the UTA scanner has another light source implemented inside the lifting cover. This arrangement allows the optical unit of the base unit to move in a synchronous way, and also provide the light to illuminate the transparent content object. This allows the optical unit to receive the transmitted light from the transparent content object, so as to obtain the shape of the image.

It should be noted that, the user could obtain information about the sensibility, respectively, for the red (R) color, green (G) color, and blue (B) color in the photosensing device 122 from the product specification of the scanner 100. In general, the photosensing device 122 does not always have the same sensibility respectively for the red (R) color, green (G) color, and blue (B) color. This would cause the color of the scanning background for the fetched image by the scanner 100 to be not the same. For example, when the product specification of the scanner 100 indicates that the ratio of R:G:B is 1.1:0.6:0.8 for the photosensing device 122, if the user uses the scanner 100 to fetch the image, then the color of the scanning background for the fetched image will be slightly toward the red color. However, some users specifically intend to process the color of the background of the fetched image due to the actual image design or the need of the beatification on the image. For example, the user intends to obtain the image with the color of the background to be slightly toward a green color, a blue color, or any other color but a red color. In this situation, the scanner 100 will longer satisfy the user's requirement for compensating the desired color of the background. It is then rather a poor performance. Thus, how to design the scanner to be able to change the color of the background for the fetched image, so as to satisfy the various requirements from the user would be a great breakthrough of the technology.

### SUMMARY OF THE INVENTION

It is therefore an objective of the present invention to provide a scanner having a transparent module used for providing a scanning background. A design for a rolling wheel with a polygon shape and hollow space in the central region can provide a transparent side plate and a plurality of color side plate, to serve as the various scanning backgrounds, so that it can satisfy the various needs from the user. In addition, the user can operate by a manual manner or by an electrical manner, so as to rotate the rolling wheel having the hollow in the central region to the desired one of the transparent side plate or the color side plate desired by the user and to face to the optical unit. It is very convenient for the user in operation.

In accordance with the foregoing and other objectives of the present invention, the invention provides a scanner, having a base unit and a lifting cover. The lift cover is implemented on the base unit in a manner capable of closing and opening. The base unit is implemented with a scanning platform and is used to allow the user to dispose thereon a content object in a reflection type or a transparent type, so as to perform the scanning operation. Under the lifting cover, a transparent window is implemented and is facing the scanning platform. The scanner includes an optical unit and a transparent module, in which the optical unit is implemented in the base unit in a movable manner, and the transparent module is implemented in the lifting cover in a movable manner that can be synchronous movement with the optical unit. The transparent module includes a housing body, a rolling wheel with N side polygon and a hollow central region, and a light source wherein, the housing body has a housing body transparent plate that is facing to transparent window. The hollow rolling wheel can be implemented on the housing body by a rotatable manner, and has one transparent side plate and a number N−1 of color side plates, in which N is a positive integer greater than 1. The hollow rolling wheel is used to allow the user to rotate it by a manual manner or by an electric power. Also, the light source is implemented on the hollow rolling wheel by a plug-in manner, so as to provide the light needed by the optical unit to scan the content object in the transparent type. In addition, when the user wants to scan the content object in the transparent type, the user can rotate the hollow rolling wheel, so that the transparent plate can be facing the transparent window. As a result, the light source can supply the light to transmit to the transparent side plate, the housing body transparent plate, the transparent window, and the transparent content object. The optical unit then can scan the transparent content object. When the user intends to select one of the color side plates to serve as the scanning background for the reflective content object, the user can rotate the hollow rolling wheel, so as to cause the selected color side plate to face the transparent window. The optical unit then can scan the reflective content object using the selected color side plate to serve as the color of the scanning background. Further still, the color of the image fetched by the optical unit would be toward to the selected color of the color side plate.

### BRIEF DESCRIPTION OF DRAWINGS

The invention can be more fully understood by reading the following detailed description of the preferred embodiments, with reference made to the accompanying drawings, wherein:

FIG. 1 is a drawing of the cross-sectional view, schematically illustrating a conventional scanner of a platform type;

FIG. 2 is a drawing of the cross-sectional view, schematically illustrating a scanner having a transparent module to provide the scanning background, according to the first preferred embodiment of the present invention;

FIG. 3 is a drawing of the top view, schematically illustrating the lifting cover shown in FIG. 2;

FIG. 4 is a circuit block diagram, schematically illustrating the control unit, the operation unit, and the modulating motor and the computer software of the scanner shown in FIG. 2;

FIG. 5 is a partially magnified drawing of the cross-sectional view, schematically illustrating the transparent module of FIG. 2 and a portion of optical unit being magnified;

FIG. 6 is a drawing of a cross-sectional view, schematically illustrating the hollow rolling wheel having a color side plate facing to the optical unit, shown in FIG. 5; and

FIG. 7 is a drawing of the top view, schematically illustrating the lifting cover of a scanner having a transparent module to provide the scanning background, according to the second preferred embodiment of the present invention.

### DETAILED DESCRIPTION OF PREFERRED EMBODIMENTS

The present invention discloses a design of a scanner having a transparent module to provide the scanning background, so as to allow the user to scan a transparent content object and reflective content object. The design of the hollow rolling wheel in the transparent module can further provide one transparent side plate and a number of color side plates, so as to serve as the various changes of the scanning background and relatively compensate the background color for the image being fetched. This has the flexibility to satisfy the requirements from the user. The actual applications of the scanner having a transparent module to provide the scanning background are described in the following with reference to the drawings of the first preferred embodiment and the second embodiment.

Embodiment 1

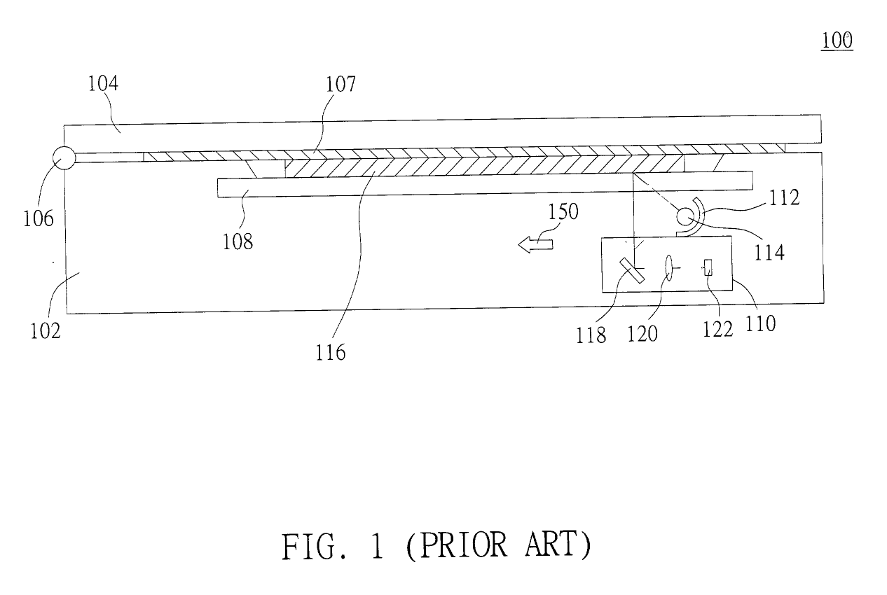

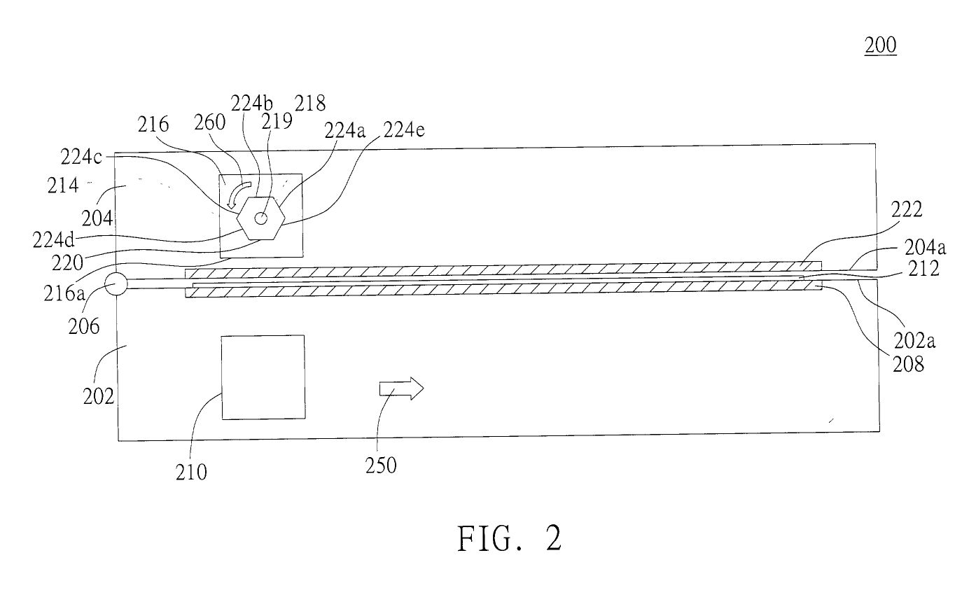

Referring to FIG. 2, it is a drawing of the cross-sectional view, schematically illustrating a scanner having a transparent module to provide the scanning background, according to the first preferred embodiment of the present invention. As shown in FIG. 2, the scanner 200 includes a base unit 202 and a lifting cover 204. The lifting cover 204 is coupled to one terminal of the base unit 202 via a pivotal pin 206, so as to implement the lifting cover 204 onto the base unit 202 capable of a closing and opening. Further still, the lifting cover 204 has a bottom plate 204a of the lifting cover, which has a transparent window 222. The base unit 202 includes the scanning platform 208 and the optical unit 210. The scanning platform 208 is implemented in the top plate 202a of the base unit 202, and the scanning platform 208 basically is a transparent glass. The scanning platform 208 is used to allow the user to dispose the content object 212 thereon, so as to perform the scanning operation. In addition, the optical unit 210 is implemented on the base unit 202 with the ability to move back and forth along the arrow direction 250, as shown in FIG. 2. The optical unit 210 includes a leading device and transmission device, whereby it can move on the base unit 202. The inner structure of the optical unit 210 and the function for all of the essential assembling elements being assembled are similar to the optical unit 110, as shown in FIG. 1. Thus, the optical unit 210 also includes a light source, a reflection mirror, a transparent lens, and a photosensing device. The locations and function for all of those essential assembling elements will not be described again here.

The present invention implements a transparent module 214 on the lifting cover 204. The transparent module 214 can be assembled in the lifting cover 204 by a method capable of moving back and forth along the arrow direction 250, as shown in FIG. 2. The transparent module 214 and the optical unit 210 are moved in a synchronous manner, so as to allow the scanner 200 to perform the scanning operation in the transparent type or the color change of the scanning background. In addition, the transparent module 214 comprises a housing body 216 and a hollow rolling wheel 218, wherein the housing body 216 includes a housing body transparent plate 216a, and the hollow rolling wheel 218 is implemented on the housing body 216 by a manner capable of rotating back and forth along the arrow direction 260, as shown in FIG. 2. Further still, the hollow rolling wheel 218 has a light source 219 and a transparent side plate 220. In addition, the light source 219 is implemented in the hollow rolling wheel 218, and can be rotated along with the hollow rolling wheel 218. The light source 219 is used to provide the light beam. The light beam is transmitted through the transparent side plate 220, the housing body transparent plate 216a, and the transparent window 222, so that the scanner 200 can scan the transparent content object.

It should be noted that the hollow rolling wheel 218 is a columnar structure with the hollow central part and a N-side polygon in cross section, in which N is an positive integer and is greater than 2, such as N equal to 6. The transparent side plate 220 is one side plate of the hollow rolling wheel 218, and the other side plates of the hollow rolling wheel 218 can be implemented or directly formed with different colors to be the color side plates, such as the color side plates 224a, 224b, 224c, 224d, and 224e, in which the color side plates 224a, 224b, 224c, 224d, and 224e respectively are the red color, green color, blue color, black color, and white color. As a result, the hollow rolling wheel 218 can allow the user to rotate and is used to further allow the user with a different color of the scanning background, so as to compensate for the background color of the image that is fetched by the scanner 200 and to satisfy the user's requirement. It is very convenient. When the color side plate is facing the transparent window 222 and the scanner 200 is performing the scanning operation, the light source 219 does not provide any light beam. At this moment, the needed light bean is completely provided by the optical unit 210 itself. In addition, the detailed structure and the moving mechanism of the transparent module 214 are separately described in the following with reference to the relevant drawings.

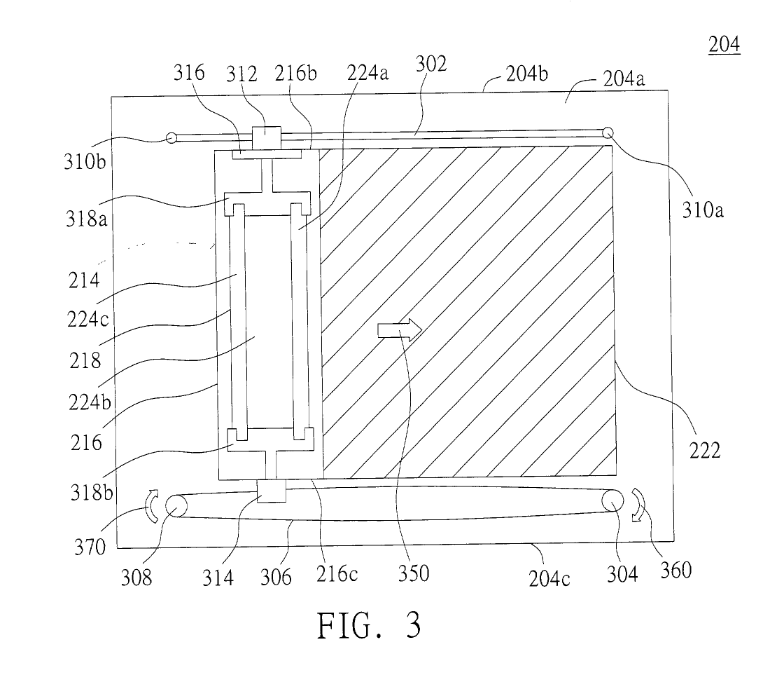

Referring to FIG. 3, it is a drawing of the top view, schematically illustrating the lifting cover of FIG. 2. As shown in FIG. 3, the lifting cover 204 also includes another leading device and another transmission device, in which the transmission device is used to provide the power and drive the transparent module 214 to move, so as to cause the transparent module 214 to be moved back and forth along the arrow direction 350, via the leading action of the leading device. Also, the transparent module 214 is moved in a manner synchronous with the optical unit 210 shown in FIG. 2, wherein the leading device can be a leading rod 302, and the transmission unit can include a step motor 304, a right-handed belt 306, and an idle wheel 308. The two terminals of the leading rod 302 are implemented on the bottom plate 204a of the lifting cover via the affixing pin 310a and 310b. The leading rod 302 is located between one side of the transparent window 222 and a side plate 204b of the lifting cover. Also, the leading rod 302 is used to couple in penetration a penetrating member 312 that is located at one side of the transparent module 214, so that the transparent module 214 can be moved by sliding on the sliding rail, which is served by the leading rode 302. The step motor 304, the right-handed belt 306, and the idle wheel 308 are all implemented on the bottom plate 204a of the lifting cover and are located between another side of the transparent window 222 and the side plate 204c of the lifting cover. The side plate 204b of the lifting cover is opposite to the side plate 204c of the lifting cover. The step motor 304 and the idle wheel 308 are respectively located at two sides of the transparent window 222. The right-handed belt 306 is affixed by fitting to the step motor 304 and the idle wheel 306, in which the right-handed belt 306 will be buckled to another side of the transparent module 214 at the buckling member 314. When the step motor rotates back and forth along the arrow direction 360 as shown in FIG. 3, the right-handed belt 306 would cause the idle wheel 308 to rotate along the arrow direction 370. Also, the right-handed belt 306 also drives the transparent module 214, so that the transparent module 214 uses the leading rode as the sliding rail and moves back and forth along the arrow direction 350, as shown in FIG. 3.

The transparent module 214 also includes a modulating motor 316, a clamping hooks 318a and 318b. The modulating motor 316 can be implemented with the housing body 216 on the housing body side plate 216b by the rotating manner, so as to allow the user to modulate the rotation. One terminal of the clamp hook 318a is hooked to one terminal of the hollow rolling wheel 218, and the other terminal of the clamp hook 318a is buckled with the modulating motor 218 and can be rotated along with the modulating motor 218. One terminal of the clamp hook 318b can be hooked to another terminal of the modulating motor 218, and the other terminal of the clamp hook 318a can be the buckled to the side plate 216c of the housing body 216 by a rotation manner. Also, the housing body side plate 216b and the housing body side plate 216c are opposite to each other. This allows the two terminals of the hollow rolling wheel 218 to be implemented in the housing body 216 via the clamp hook 318a and the clamp hook 318b. When the modulating motor 316 is rotating, the clamp hook 318a will drive the hollow rolling wheel 218 and the clamp hook 318b to rotate, so as to adjust the transparent side plate 220 or the color side plates facing the transparent window 222.

In fact, the moving action of the transparent module 214 and the moving action of the optical unit 210 are the same. With respect to the technology for the synchronous action of the transparent module 214 and the optical unit 210 can just follow the current synchronous technology used in the scanner of the upper transparency adapter (UTA) type. Therefore, it is not further described here.

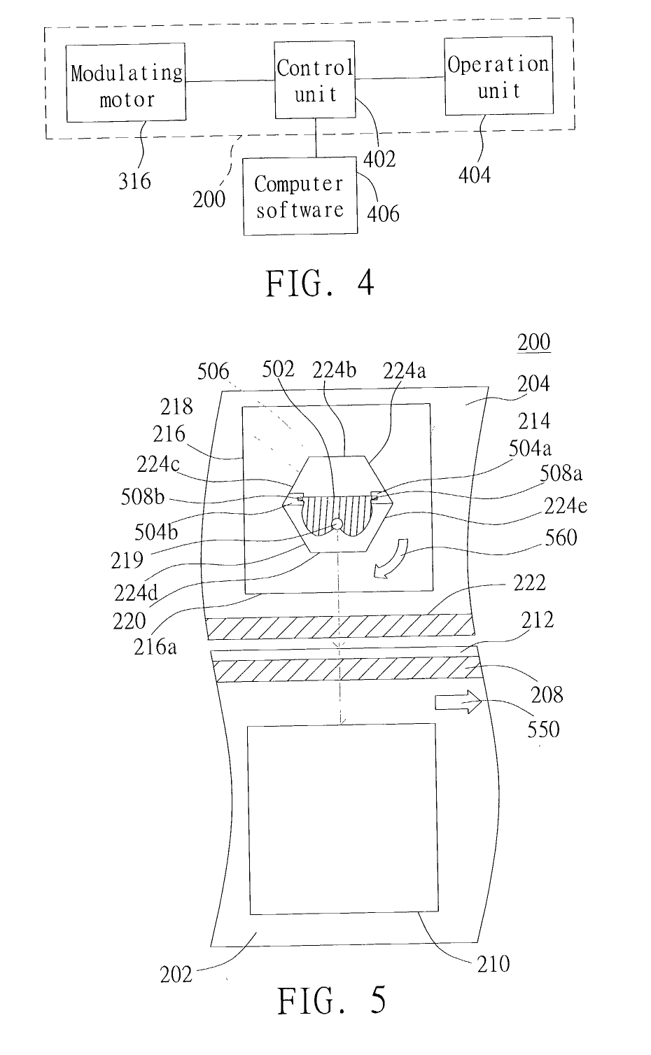

It should be noted that the scanner 200 also includes a control unit 402 and an operation unit 404, as shown in FIG. 4, which is a circuit block diagram, schematically illustrating the control unit, the operation unit, and the modulating motor and the computer software of the scanner of FIG. 2. As shown in FIG. 4, the modulating motor 316 and the operation unit 404 are coupled with the control unit 402. The operation unit 404 can be implemented at the outside of the scanner 200, so that the user can operate and thereby input a modulating signal. Also, the control unit 402 receives the modulating signal and drive the modulating motor 316 for rotation, so that the hollow rolling wheel 218 will rotate along the arrow direction 260 as shown in FIG. 2 until the transparent side plate 220 or the color side plate needed by the user has faced to the transparent window 222.

In addition, when the scanner 200 is coupled with an external computer system, the control unit 402 will receive the computer software 406 installed by the external computer system. The computer software 406 allows the user to operate from the window, and thereby to export a computer modulating signal. Also, the control unit 402 will receive the computer modulating signal and drive the modulating motor 316 for rotation. As a result, the hollow rolling wheel 218 can be rotated to have the transparent side plate 220 or the color side plate, which is needed by the user, to face to the transparent window 222. Of course, the computer software 406 can also be directly installed inside the scanner 200 to be a control software. The user can directly operate the control software from the liquid crystal display panel (LCD panel) of the scanner, so as to rotate the modulating motor 316. It is very convenient. to the method of implementing the light source 219 in the hollow rolling wheel 218 is described in the following.

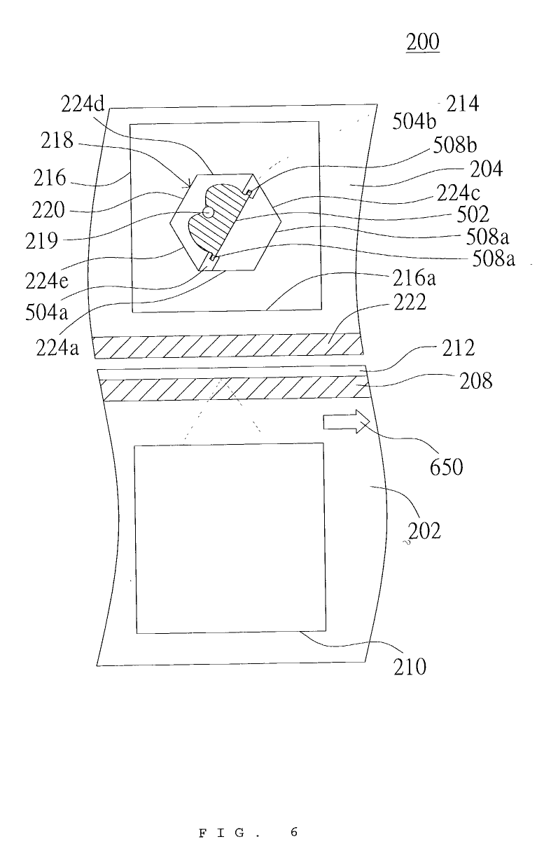

Referring to FIG. 5, it is a drawing of a cross-sectional view, schematically illustrating the hollow rolling wheel having a color side plate facing to the optical unit. As shown in FIG. 5, the hollow rolling wheel 218 has a holding rack 502 for the light source, a groove 504a and a groove 504b. The holding rack 502 for the light source is implemented on the hollow rolling wheel 218 by a manner of plugging in and pulling out, and also has an inserting groove 506, and protruding parts 508a and 508b. The inserting groove 506 is used for the light source 219 to be disposed in, and the protruding parts 508a and 508b are used to be buckled with the grooves 504a and 504b, respectively. Thereby, the light source 219 can be plugged in or pulled out from the hollow rolling wheel 218 via the holding rack 502 for the light source. Further still, the light beam provided by the light source 219 can only transmit through the transparent side plate 220, the housing body transparent plate 216a, and the transparent window 222, so as to illuminate the content object 212 and achieve the effect of scanning the content object. The light source 219 can be a single bulb or a dual bulb type, and can also be implemented to the hollow rolling wheel 218 via the other buckling device.

For the case that the user intends to scan a content object 212 of the transparent type. If the transparent side plate 220 is not facing to housing body transparent plate 216a, the transparent window 222, the transparent content object 212, the scanning platform 208 and the optical unit 210, then the user first operates the operation unit 404 or the computer software 406, as shown in FIG. 4, and thereby exports the modulating signal or the computer modulating signal. Then, the control unit 402 of FIG. 4 will receive the modulating signal or the computer modulating signal and drive the modulating motor 316 for rotation. The hollow rolling wheel 218 will rotate together with the modulating motor 316 until the transparent side plate 220 has faced to the housing body transparent plate 216a, the transparent window 222, the content object 212, the scanning platform 208, and the optical unit 210. Then, the light source 219 will provide the light beam. The light beam can only pass through the transparent side plate 220, the housing body transparent plate 216a, the transparent window 222, and the content object 212. Next, the optical unit 210 will receive the light beam transmitting through the content object 212 and fetch the image. Then, the transparent module 214 and the optical unit 210 together move along the arrow direction 550, as shown in FIG. 5, so that the optical unit 210 can achieve the scanning action on the content object 212 and obtain a complete image that is fetched.

When the content object 212 is a reflection type and the user intends to fetch the image with the intention of changing the background color toward to a red color, then the user has to put the color side plate with the red color to face to the housing body transparent plate 216a and the transparent window 222 to serve as the scanning background. If the color side plate 224a is not facing to the housing body transparent plate 216a and the transparent window 222, then first the user has to operate the operation unit 404 or the computer software 406, as shown in FIG. 4, and respectively export the modulating signal or the computer modulating signal. Then, the control unit 402 of FIG. 4 receives the modulating signal or the computer modulating signal, so as to drive the modulating motor 316 for rotation and the hollow rolling wheel 218 for rotating along the arrow direction 560, as shown in FIG. 5, until the color side plate 224a has faced to the housing body transparent plate 216a, the transparent window 22, the content object 212, the scanning platform 208, and the optical unit 210, as shown in FIG. 6, which is a drawing for a cross-sectional view, schematically illustrating the hollow rolling wheel having a color side plate facing to the optical unit, shown in FIG. 5. Next, the light source 219 will not provide any light beam. Instead, the optical unit 210 provides the light beam needed, and then the content object 212 reflects the light beam. The optical unit 210 will then receive the reflected light from the content object 212 and fetch the image. The transparent module 214 and the optical unit 210 are moved together in a synchronous manner along the arrow direction 650 shown in FIG. 6. As a result, the optical unit 210 can accomplish the operation of scanning the content object 212 to obtain the fetched image being fully integrated. Also, the color of background for the fetched image would be shifted to the red color, satisfying the requirement from the user. When the user intends to have the other color side plate to be the scanning background, the user can also follow the foregoing adjusting procedure to achieve that purpose.

However, the person skilled in the art will understand that the technology of the present invention is not restricted to the foregoing descriptions. For example, the hollow rolling wheel 218 can be a columnar structure with the hollow central part, having the polygon shape in cross-section with four sides or eight sides, so that the number of the color side plates and the color of the scanning background can be increased or decreased. This can be further designed, according to the actual intention of the user, and this is also very convenient.

Embodiment 2

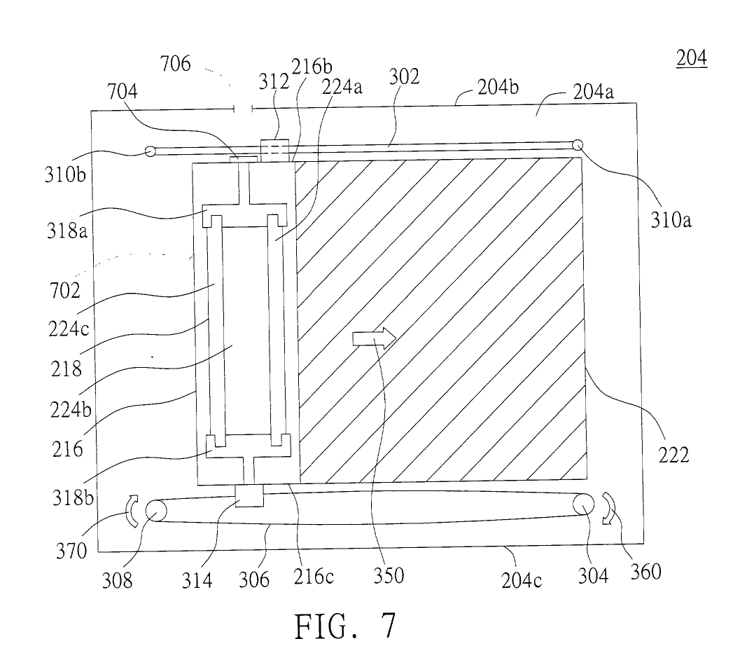

Referring to FIG. 7, it is a drawing of the top view, schematically illustrating the lifting cover of a scanner having a transparent module to provide the scanning background, according to the second preferred embodiment of the present invention. As shown in FIG. 7, the difference when comparing embodiment 2 with the embodiment 1 of FIG. 3 is that the transparent module 214 is using the modulating motor 316 in an electrical manner to allow the user to rotate the hollow rolling wheel 218. In the embodiment of the present invention, the user has to use the screwdriver or another auxiliary tool to deeply reach to the lifting cover 204, and rotate the hollow rolling wheel 218 inside the transparent module 702 by a manual manner. In this embodiment, the other structure parts of the scanner is similar to the scanner 200 described in the embodiment 1, and thus, the details are not further described here.

Referring to FIG. 7, in the transparent module 702, one terminal of the clamp hook 318a is also hooked to one terminal of the hollow rolling wheel 218, and the other terminal of the clamp hook 318a does penetrate the housing body side plate 216a and is buckled with a rotation member 704 of the housing body side plate 216a, in which the transparent module 702 has a home position. This embodiment particularly designs an opening 706 formed in the lift cover side plate 204b. When the transparent module 702 is located at the home position, the opening 706 is with respect to the rotation member 704, and allows the user to use a screwdriver or some other auxiliary tool to insert into the opening 706 and touch on the rotation member 704, so that the user can rotate the rotation member 704 and the hollow rolling wheel 218, resulting in very convenient adjustments. The principles of this embodiment of a scanner for scanning the transparent content object or the reflective content object, are all the same as those of the embodiment 1, and therefore the details are not further described here. The only difference between two embodiments is that the user has to use the auxiliary tool to deeply reach to the lifting cover 204, so as to rotate the hollow rolling wheel 218.

When the transparent module 702 is located at the home position, as shown in FIG. 7, the rotation member 704 is just with respect to the opening 706. First, the user uses an auxiliary tool to insert into the opening 706 from the exterior of the lifting cover side plate 204b, so that it allows the auxiliary tool to stop and control on the rotation member 704. Then, the user can rotate the rotation member 704 by a manual manner via the auxiliary tool. As a result, the clamp hook 318a, the hollow rolling wheel 218, and the clamp hook 318b are rotated together with the rotation member 704. Next, when the user observes from the transparent window 222 that the transparent side plate or the color side plate desired by the user is suitably close to the transparent window 222, the user then stops rotating the rotation member 704. As a result, the transparent side plate or the color side plate desired by the user is facing now to the transparent window 222.

The person skilled in the art will understand that the technology of the present invention is not only restricted to the forgoing disclosure. For example, the light source, the holding rack of the light source, and the transparent side plate of the hollow rolling wheel of the present invention can be saved in design. This allows the side plates of the hollow rolling wheel to be all in color side plates. This will provide one more choice for the user to have the scanning background, resulting in a very convenient use.

In summary, the foregoing embodiments of the present invention have disclosed the scanner that has the transparent module for providing the choice of the scanning background, which has of the following advantages.

1. It includes a design of the hollow rolling wheel with the polygon shape, which can provide one transparent side plate and a number of color side plates, all of which can provide various scanning backgrounds, so as to satisfy the user's requirement.

2. The user can rotate the hollow rolling wheel by a manual manner or an electrical power manner to have one of the transparent side plate or the color side plates desired the user to face to the optical unit. This is very convenient to operate.

The invention has been described using exemplary preferred embodiments. However, it is to be understood that the scope of the invention is not limited to the disclosed embodiments. On the contrary, it is intended to cover various modifications and similar arrangements. The scope of the appended claims, therefore, should be accorded the broadest interpretation so as to encompass all such modifications and similar arrangements.

What is claimed is:

1. A scanner, having a base unit and a lifting cover, wherein the lifting cover can be implemented on the base unit in a manner of opening and closing, the base unit is implemented with a scanning platform, used to allow a user to dispose a reflective content object or a transparent content object thereon, so as to perform a scanning operation, the lifting cover is implemented with a transparent window, the transparent window is facing the scanning platform, the scanner comprising:
an optical unit, which is implemented on the base unit in a movable manner; and
a transparent module, which is implemented in the lifting cover in a movable manner that can be synchronously moved with the optical unit, the transparent module comprising:
a housing body, having a housing body transparent plate that is facing the transparent window;
a hollow rolling wheel with N sides, which is implemented in the housing body by a rotatable manner, wherein the hollow rolling wheel includes one transparent side plate and a number N−1 of color side plates, in which N is a positive integer greater than 1, the hollow rolling wheel can allow the user to be rotated by a manual manner or an electric power manner; and
a light source, which is implemented in the hollow rolling wheel by a plug-in manner, so as to provide the light beam for the optical unit while scanning the transparent content object;
wherein when the user intends to scan the transparent content object, the user rotates the hollow rolling wheel, so as to cause the transparent side plate to face to the housing body transparent plate, wherein the light source provides the light beam to transmit the transparent side plate, the housing body transparent plate, the transparent window, and the transparent content object, the optical unit then can scan the transparent content object,
when the user intends to select one of the color side plates to serve as a scanning background for scanning the reflective content object, the user rotates the hollow rolling wheel, so as to cause the one of the color side plates to face the housing body transparent plate, the optical unit then uses the selected one of the color side plates as the scanning background for scanning the reflective content object, and perform the scanning operation, also and a fetched image by the optical unit is toward, in color, the color of the selected one of the color side plates.

2. The scanner as recited in claim 1, wherein the housing body further comprises:
a first housing side plate;
a second housing side plate, which is opposite to the first housing side plate;
a first clamp hooker, of which one terminal is hooked to one terminal of the hollow rolling wheel, the other terminal of the first clamp hooker is implemented on an inner wall of the first housing side plate in a movable manner; and
a second clamp hooker, of which one terminal is hooked to the other terminal of the hollow rolling wheel, wherein the other terminal of the second clamp hooker is implemented on an inner wall of the second clamp hooker in a movable manner.

3. The scanner as recited in claim 2, further comprising:
an operation unit, used to allow the user to operate and export a modulating signal;
a modulating motor, which is implemented on an inner wall of the first housing side plate by a rotatable manner, is buckled with the first clamp hooker; and
a control unit, which is couple to the operation unit and the modulating motor, so as to receive the modulating signal and drive modulating motor for rotation, wherein the user can use an electric power to rotate the hollow rolling wheel;
wherein when the user does operation on the operation unit, the operation unit the exports the modulating signal, the control unit receives the modulating signal and drive the modulating motor, the first clamp hooker, the hollow rolling wheel, and the second clamp hooker to rotate together with modulating motor, wherein when the one of the transparent side plate or the color side plate needed by the user is close to the housing body transparent plate, the modulating motor stops in action, so that the selected one of the transparent side plate or the color side plate needed by the user is just facing the housing body transparent plate.

4. The scanner as recited in claim 2, further comprising:
an opening, located at a lifting cover side plate of the lifting cover; and
a rotating member, which is implemented on an outer side wall of the first housing body side plate by a rotatable manner, and is buckled with the first clamp hooker,
wherein when the transparent module is located at a home position, the rotation member is with respect to the opening, wherein the user can use an auxiliary tool to insert into the opening from the lifting cover side plate, so that the auxiliary tool can stop and touch on the rotation member, whereby the user can use the auxiliary tool to rotate the rotation member by a manual manner, so that the first clap hooker, the hollow rolling wheel, and the second clamp hooker can be rotated together with the rotation member, when the user observers by eye from the transparent window and knows a selected one by the user selected from the group consisting of the transparent side plate and the color side plates is close to the transparent window, the user then stops rotating the rotation member, and the selected one by the user selected from the group consisting of the transparent side plate and the color side plates is just facing the transparent window.

5. The scanner as recited in claim 1, wherein the number N−1 of the color side plates has N−1 different colors.

6. The scanner as recited in claim 5, wherein the quantity of the number N is equal to 6.

7. The scanner as recited in claim 1, wherein the transparent module further comprises:
a holding rack for the light source, which is buckled on an inner wall of the hollow rolling wheel in a plug-in manner, wherein the holding rack for the light source includes an inserting groove, used to dispose the light source, so that the light source is implemented on the hollow rolling wheel via the holding rack for the light source.

8. The scanner as recited in claim 7, wherein the inner wall of the hollow rolling wheel has a first sliding groove and a second sliding groove, and the holding rack for the light source has a first protruding member and a second protruding member, so as to respectively buckled to the first sliding to groove and the second sliding groove, so that the holding rack for the light source is implemented on the hollow rolling wheel.

9. The scanner as recited in claim 1, further comprising:
a transmission device, used to provide the transmission power and drive the transparent module to move back and forth; and
a leading device, used to serve as a sliding rail for the transparent module while moving.

10. A scanner, having a base unit and a lifting cover, wherein the lifting cover can be implemented on the base unit in a manner of opening and closing, the base unit is implemented with a scanning platform, used to allow a user to dispose a reflective content object or a transparent content object thereon, so as to perform a scanning operation, the lifting cover is implemented with a transparent window, the transparent window is facing the scanning platform, the scanner comprising:
an optical unit, which is implemented on the base unit in a movable manner;
a housing body, having a housing body transparent plate, wherein the housing body transparent plate is facing the transparent window; and
a hollow rolling wheel with N sides, which is implemented on the housing body by a rotation manner, wherein the hollow rolling wheel includes a plurality of color side plates by N, the hollow rolling wheel is used to allow the user to rotate by a manual manner or an electrical power manner, wherein the quantity of N is an positive integer greater than 2,
wherein when the user scan the reflective content object and the user intends to select one of the color side plates to serve as a scanning background for scanning the reflective content object, the user rotates the hollow rolling wheel, so as to cause the one of the color side plates to face to the housing body transparent plate, the optical unit then uses the selected one of the color side plates as the scanning background for scanning the reflective content object, and perform the scanning operation, also and a fetched image by the optical unit is toward, in color, the color of the selected one of the color side plates.

11. The scanner as recited in claim 10, wherein the housing body further comprises:
a first housing side plate;
a second housing side plate, which is opposite to the first housing side plate;
a first clamp hooker, of which one terminal is hooked to one terminal of the hollow rolling wheel, the other terminal of the first clamp hooker is implemented on an inner wall of the first housing side plate in a movable manner; and
a second clamp hooker, of which one terminal is hooked to the other terminal of the hollow rolling wheel, wherein the other terminal of the second clamp hooker is implemented on an inner wall of the second clamp hooker in a movable manner.

12. The scanner as recited in claim 11, further comprising:
an operation unit, used to allow the user to operate and export a modulating signal;
a modulating motor, which is implemented on an inner wall of the first housing side plate by a rotatable manner, is buckled with the first clamp hooker; and
a control unit, which is couple to the operation unit and the modulating motor, so as to receive the modulating signal and drive modulating motor for rotation, wherein the user can use an electric power to rotate the hollow rolling wheel;
wherein when the user does operation on the operation unit, the operation unit the exports the modulating signal, the control unit receives the modulating signal and drive the modulating motor, the first clamp hooker, the hollow rolling wheel, and the second clamp hooker to rotate together with modulating motor, wherein when the one of the transparent side plate or the color side plate needed by the user is close to the housing body transparent plate, the modulating motor stops in action, so that the selected one of the transparent side plate or the color side plate needed by the user is just facing the housing body transparent plate.

13. The scanner as recited in claim 11, further comprising:
an opening, located at a lifting cover side plate of the lifting cover; and
a rotating member, which is implemented on an outer side wall of the first housing body side plate by a rotatable manner, and is buckled with the first clamp hooker,
wherein when the transparent module is located at a home position, the rotation member is with respect to the opening, wherein the user can use an auxiliary tool to insert into the opening from the lifting cover side plate, so that the auxiliary tool can stop and touch on the rotation member, whereby the user can use the auxiliary tool to rotate the rotation member by a manual manner, so that the first clap hooker, the hollow rolling wheel, and the second clamp hooker can be rotated together with the rotation member, when the user observers by eye from the transparent window and knows a selected one by the user selected from the group consisting of the transparent side plate and the color side plates is close to the transparent window, the user then stops rotating the rotation member, and the selected one by the user selected from the group consisting of the transparent side plate and the color side plates is just facing the transparent window.

14. The scanner as recited in claim 10, wherein the color side plates by N have N different colors.

15. The scanner as recited in claim 14, wherein the quantity of the number N is equal to 6.

16. The scanner as recited in claim 10, further comprising:
a transmission device, used to provide a transmission power and drive the transparent module to move back and forth; and
a leading device, used to serve as a sliding rail for the transparent module while moving.
